(19) United States
(12) Patent Application Publication
(10) Pub. No.: US 2024/0241247 A1
(43) Pub. Date: Jul. 18, 2024

(54) AUTONOMOUS GPR SYSTEM

(71) Applicant: PROCEQ SA, Schwerzenbach (CH)

(72) Inventors: Marcel POSER, Oberuzwil (CH); Antonio CABALLERO, Volketswil (CH); Jonas ZOLLIKER, Dübendorf (CH)

(73) Assignee: PROCEQ SA, Schwerzenbach (CH)

(21) Appl. No.: 18/563,960

(22) PCT Filed: May 25, 2021
(86) PCT No.: PCT/EP2021/063903

§ 371 Date: Nov. 24, 2023

(51) Int. Cl. G01S 13/88; G01V 3/17; G05D 1/648; G05D 105/80; G05D 109/12; G05D 111/30

(52) U.S. Cl. CPC G01S 13/885; G01V 3/17; G05D 1/648; G05D 2105/87; G05D 2109/12; G05D 2111/30

(57) ABSTRACT

GPR system and method for autonomously conducting a GPR survey of a subsurface bounded by a surface by a GPR device. The GPR device is mechanically connected to an autonomous robot. The method includes defining a survey path on the surface in a survey geometry; causing the robot to autonomously move along the survey path, thereby controlling a position of the GPR device; transmitting, via the GPR device, radar waves into the subsurface and recording their echoes as GPR data together with position data indicative of the position of the GPR device. The GPR system acquires GPR data of a subsurface bounded by a surface. The GPR system includes an autonomous robot, in particular with legs, and a GPR device, in particular which alternatively may be used as a stand-alone device.

### TECHNICAL FIELD

The invention relates to a method for autonomously conducting a GPR survey, an autonomous GPR system and a use of the autonomous GPR system.

### BACKGROUND ART

Ground-penetrating radar (GPR) is a conventional method for nondestructive testing (NDT) as well as for geophysical or geological studies. A GPR antenna emits a radar wave, typically in a frequency band between 10 MHz and 3.5 GHz, into a subsurface or an object to-be-tested, and receives reflected radar waves back from the subsurface or, respectively, the object. The reflected radar waves are then processed, e.g. to generate an image of or to determine physical properties of the subsurface or, respectively, the object.

Conventional GPR devices comprise the GPR antenna and a control unit configured to control the antenna and to record GPR data received from the GPR antenna. Conventionally, GPR devices are pushed or towed manually along a survey path, i.e. a line along which GPR data is acquired. Alternatively, GPR devices are mounted to a vehicle, such as a car, which is manually controlled by a driver to move along the survey path.

Such method of manually conducting a GPR survey has several disadvantages: Firstly, it is time-consuming because a human operator is required at all times during the GPR survey. Secondly, depending on the terrain or accessibility of the survey area, conducting the GPR survey may be tedious and wearisome for the operator. Thirdly, for some survey areas, conducting the survey by a human operator may not be desirable at all, e.g. because of dangers to health or life of the operator, such as on a mine field or an oil platform.

### DISCLOSURE OF THE INVENTION

The problem to be solved by the present invention is therefore to provide a method and a corresponding system for conducting a GPR survey, which overcomes the above disadvantages. In particular, the method shall be efficient, timesaving and safe for a human operator as well as feasible in remote or inaccessible survey areas.

According to a first aspect of the invention, this problem is solved by a method for autonomously conducting a GPR survey of a subsurface by means of a GPR device.

The subsurface in particular may be any medium bounded by a surface, on or over which the GPR device may be moved. The subsurface may e.g. be within an object to-be-tested for integrity or defects, such as a building or construction, or it may be an underground, such as a pavement or soil. The GPR survey in particular includes acquiring GPR data by transmitting radar waves into the subsurface and receiving reflected radar waves which are reflected by boundaries or other changes of material properties in the subsurface.

Autonomous in particular means without any human input, or in other words, self-controlled or independent from any human operator during the GPR survey.

According to the method, the GPR device is mechanically connected to an autonomous robot. The method comprises the steps of
defining a survey path on the surface in a survey geometry: The survey geometry may e.g. comprise an area where GPR data is to be acquired, i.e. a survey area. The survey path may be pre-defined survey path, i.e. provided by a human operator. Alternatively, the survey path may automatically be determined before the survey, e.g. based on the survey area. Or the survey path may even be adjusted, in particular automatically adjusted, during the survey, e.g. based on sensor data acquired by the robot, such as a camera or proximity sensor.

Advantageously, the survey geometry, which is required for performing the above step, may be received, when performing the method. In one embodiment, this comprises obtaining map data defining the survey geometry. In a further embodiment, it comprises detecting delimiters of the survey geometry using sensors of the robot, e.g. a camera, a lidar or an RF transducer. Delimiters may e.g. be walls or obstacles present in the survey area. Alternatively or in addition, delimiters may comprise installed delimiters delimiting the survey area, such as RFID tags that may be detected by an RF transducer of the robot.
causing the robot to autonomously move along the survey path, thereby controlling a position of the GPR device: Since the GPR device is mechanically connected to the robot, the GPR device's position depends on a position of the robot. In an embodiment, the GPR device may be directly mounted to the robot, meaning that the GPR device is not in contact with the surface but in particular fully supported by the robot. In another embodiment, the GPR device may comprise a cart or sledge separate from the robot, which is towed or pushed on the surface by the robot.
by means of the GPR device, transmitting radar waves into the subsurface and recording their echoes as GPR data together with position data indicative of the position of the GPR device: The data indicative of the position of the GPR device may in particular comprise the position of the GPR device, e.g. as measured by a GNSS receiver. Alternatively, the data may comprise a position and orientation of the robot, e.g. as measured by sensors, such as a GNSS receiver and a magnetometer, of the robot, from which the position of the GPR device is derivable. The position data may alternatively or additionally be determined by a simultaneous localization and mapping (SLAM) algorithm, as e.g. described in the Wikipedia article on “Simultaneous localization and mapping” revised on May 6, 2021. For this purpose sensor data may be acquired by sensors of the robot, such as a camera, a lidar, a laser range finder and an IMU, and processed by a SLAM algorithm. Thus, in general, the position data may be retrieved outdoors as well as indoors. Also, the whole method for autonomously conducting a GPR survey may be applied outdoors as well as indoors.

In an embodiment, the above described steps are not performed sequentially, but are interchanged or iterated. In particular, a first section of the survey path may be defined when receiving a first version of the survey geometry, e.g. initial map data. A second section of the survey path may then be defined or adapted after receiving a second version of the survey geometry, e.g. additional sensor data about delimiters, such as obstacles in the survey area.

Evidently, such autonomous method saves time when conducting a GPR survey. Further, it facilitates GPR surveys in areas that pose threats to human health or even life.

Advantageously, the GPR device is adapted to perform a GPR survey in connection with but also without the autonomous robot. In other words, the GPR device may be a conventional GPR device, in particular moved along the survey path manually or manually controlled. In this case, the method further comprises the steps of carrying out several surveys and, for each survey, mechanically connecting the GPR device to the autonomous robot, and after recording the GPR data, disconnecting the GPR device from the autonomous robot. Such method is versatile in terms of applications since the GPR device may be used for both, autonomous and manual surveys. Also, the robot may be used for other purposes, for which the GPR device may not be desired to be connected to the robot.

In an embodiment, the method further comprises towing the GPR device behind the autonomous robot along the survey path. For this purpose, the GPR device may comprise a radar antenna arranged on a cart with wheels or on a sledge. The cart or sledge is mechanically connected to the autonomous robot via a connector, in particular wherein the connector comprises a ball joint. The GPR device comprising a cart or sledge separate from the robot has the advantage that the robot does not need to support a full weight of the GPR device. This is particularly advantageous in view of a typical weight of GPR devices being of the order of 10 kg or more.

Advantageously, the method further comprises lowering or raising the connector dependent on a position of the GPR device on the survey path. This may be useful in case of obstacles or a roughness of the surface. Also, the connector may particularly be raised or lowered in bends along the survey path, e.g. thereby lifting a part of the wheels of the cart from the surface. In this way, the cart may be more easily towed along the bend.

Alternatively, the connector may be adapted to connect the GPR device to the robot such that only one or two of the wheels of the cart are in contact with the surface. This again facilitates towing the cart along bends.

In an advantageous embodiment, the autonomous robot is a robot with legs. In this case, causing the robot to move along the survey path comprises moving the legs of the robot, thereby moving the robot along the survey path. Such robot does not require wheels or chains for locomotion. In particular, such robot is all-terrain capable and may even move on stairs. The latter is advantageous in inaccessible areas or on/in technical constructions, such as an oil platform, on which GPR data are to be measured without a human operator being present on-site.

In general, it may be advantageous that the method comprises controlling a distance between the GPR device and the surface, e.g. in case of obstacles or surface roughness or for ensuring coupling or a good signal transmission into the subsurface. In particular, the distance may be controlled to be below a threshold, e.g. below 0.1 m. In the case of a robot with legs, the distance may be controlled by moving the legs of the robot to adjust the distance. Alternatively, the distance may be controlled by lowering or raising the connector in another way, e.g. by a lift motor.

In an embodiment of the method, the survey geometry comprises a survey area and further survey parameters, in particular a measurement spacing, as input parameters. In such case, defining the survey path advantageously comprises generating the survey path to cover the survey area while taking into account the further survey parameters, in particular the measurement spacing. This may be done automatically, e.g. by a control unit of the robot. In particular, generating the survey path may include solving an optimization problem, e.g. minimizing a length of the survey path, while fulfilling certain constraints expressed by the further survey parameters, such as ensuring the given measurement spacing.

The further survey parameters may also comprise a resolution of the GPR data or geometrical constrains. Conventional algorithms for processing the GPR data and in particular imaging the subsurface assume that the GPR data is acquired along straight lines, meaning that the survey path should comprise a high portion of straight lines, e.g. at least 50% or 80% of an overall length of the survey path should be straight. This typically leads to a survey path in the shape of a meander. Accordingly, the survey path may be generated to exhibit a meander shape as an additional constraint.

A second aspect of the invention relates to an autonomous GPR system for acquiring GPR data of a subsurface bounded by a surface. Such system comprises an autonomous robot, in particular with legs, and a GPR device. In particular, the system may be configured to execute the method described above.

All features that are described with regard to the method are also applicable to the system, and vice versa.

In an embodiment, the robot comprises at least two, in particular four, legs with actuators, and a robot control unit. The robot control unit is configured to control the actuators to autonomously move the robot on the surface along a survey path in a walking mode by means of the legs. As described above, such robot is all-terrain capable.

Alternatively, wherein the autonomous robot may comprise wheels or chains for locomotion. For many application, such as probing a pavement or the soil below a reasonably flat surface, this may be sufficient. All features described are, where feasible, applicable to any type of autonomous robot, in particular a robot with legs as well as a robot with wheels or chains.

Advantageously, the system comprises a position determining unit, in particular a GNSS receiver. Further, the GPR device typically comprises a GPR antenna configured to transmit and receive radar waves and a GPR control unit. The GPR control unit is connected to the GPR antenna and to the position determination unit. The GPR control unit comprises a data recorder recording GPR data received from the GPR antenna together with corresponding position data received from the position determination unit.

The position determining unit may be mechanically mounted or mountable on the GPR device. In this case, the position data received from the position determination unit may be indicative of the position of the GPR device without further calculations.

Alternatively, the position determining unit may be mounted or mountable on the robot. In such case, the position data includes a position and advantageously also an orientation of the robot. From such position data, the position of the GPR device, i.e. the position where the GPR data is acquired, may be estimated assuming a fixed relationship between GPR device and robot, in particular a known distance and orientation, as e.g. defined by three angles, between GPR device and robot.

In an embodiment, the GPR device is towed behind—as seen in a direction of movement along the survey path—the robot. In that case, it is advantageously assumed that the GPR device is towed behind the robot without lateral deflection, i.e. the GPR device follows the same survey path as the robot. Then, the position of the GPR device may be calculated from the position and orientation of the robot and the known distance between GPR device and robot. Such considerations are in particular applicable to the following embodiment.

In this embodiment, the GPR device comprises a cart with wheels or a sledge, to which the GPR antenna is mounted. As mentioned before, such GPR device may be a conventional GPR device, e.g. for application on soil, which is typically pushed or towed by a human operator. In particular, such cart or sledge comprises a handle.

Advantageously, the system comprises a connector configured to removably connect the GPR device to the robot. In particular, wherein the connector may comprise a clamp configured to removably hold the handle of the cart or sledge. In other embodiment, e.g. if the GPR device is mountable directly to the robot, the connector may comprise a slide lock.

In an embodiment, the connector comprises a ball joint. In other words, the connector advantageously exhibits three rotational degrees of freedom between the robot and the GPR device. At the same time, the connector advantageously is rigid along three translational degrees of freedom between the robot and the GPR device. Alternatively, the connector may comprise a flexible element, e.g. a spring or a rubber element, to reduce accelerations between robot and GPR device. In particular, the flexible element defines a position of the GPR device relative to the robot within an accuracy of 10% or less of a dimension of the connector, in particular within 1% or less. This ensures a flexible mechanical connection between GPR device and robot, which is well suited e.g. for towing a cart with wheels or a sledge over uneven terrain, such as a field or rocky ground in geophysical or agricultural applications. At the same time, a good coupling of the GPR device to the ground and thus a good GPR signal transmission is ensured.

In an embodiment, the robot further comprises a main body having a bottom side and a top side. The legs extend from the main body beyond the bottom side. Advantageously, the connector is arranged on the top side. This facilitates towing the cart or sledge and overcoming surface roughness or obstacles along the survey path.

In an embodiment, the robot comprises a lift drive connected to the robot control unit and configured to lower or raise the connector. In particular, the lift drive is adapted to move the connector between a first and a second vertical position, thereby tilting the cart between a first and a second tilting position. The first tilting position may e.g. correspond to a situation in which all wheels of the cart or an entire bottom side of the sledge abuts on an, in particular even, surface. The second tilting position may then correspond to a part of the wheels of the cart, e.g. two front wheels, lifted off the surface, or, respectively, only an edge of the bottom side of the sledge abutting on the surface. In the second tilting position, manoeuvrability of the cart or sledge, e.g. around bends along the survey path, may be better. Alternatively, in case of a robot with legs, the same effect may be achieved by lowering or raising the main body of the robot through a corresponding movement of the legs controlled by the robot control unit.

Further, the connector or the GPR device, in particular the handle, may comprise a hinge, in particular pivotal around a horizontal axis, in particular perpendicular to a forward direction along the survey path. The hinge may be spring mounted or comprise an actuator for active adaptation.

As mentioned before, the robot control unit may be configured to generate the survey path based on a survey area and further survey parameters, in particular a measurement spacing and/or resolution. In particular, a constraint may be that the GPR data acquired along the survey path covers the survey area, e.g. within a given spatial resolution.

Instead of the GPR device being itself in contact with, i.e. directly abutting on, the surface, such as in the case of a cart or sledge towed behind the robot, the GPR device may alternatively be directly mountable to the robot by means of the connector. This means that the GPR device, in an operating position, is not in contact with the surface. Such type of connection between GPR device and robot allows for other design options for the GPR device, e.g. a less robust bottom side. Also, such type of connection facilitates GPR surveys in areas which are not accessible with a wheeled cart, such as stairs, e.g. on an oil platform.

In an embodiment, the connector comprises an arm with at least one arm actuator connected to the robot control unit. The GPR device may then be connected to a distal end of the arm. The arm is advantageously configured to support a full weight of the GPR unit. In particular, the at least one arm actuator is configured to move the GPR device in at least five, in particular six, degrees of freedom relative to a main body of the robot. In that way, the GPR device and in particular the GPR antenna may be oriented in an arbitrary direction, not only a horizontal surface but also against a wall or ceiling, e.g. for acquiring radar data on a construction site or in a tunnel or pipe.

In case, the GPR device is directly mounted to the robot, the robot control unit is advantageously configured to control a position and in particular an orientation of the GPR device. In particular, the position of the GPR device may be controlled such that a distance between the GPR device and the surface does not exceed a threshold. Further, the orientation of the GPR device may be controlled such that a main transmission direction of the GPR antenna is aligned with a normal direction, which may e.g. be orthogonal to the surface, e.g. a wall, or parallel to gravity, e.g. on a sloping surface.

A third aspect of the invention relates to different possible uses of the above system. The system may in particular be used for at least one of:
mapping geological features in the subsurface: In that case, the subsurface may e.g. comprise soil, bedrock, groundwater or ice. Geological features may be layers of different material, e.g. rock or groundwater.
locating man-made features or defects in the subsurface, in particular in a construction or a pavement: Such man-made features may include pipes, electrical lines and tunnels. Constructions may e.g. include large concrete areas, such as bridge decks and parking garages.
estimating an amount of biomass, in particular roots, in the subsurface: This is useful in the field of agriculture, where the amount of biomass below the surface may be measured as an indicator of plant growth, e.g. on a crop field or other plantation. For such application, the system described above may be of particular advantage because it is able to move along a survey path between rows of plants, in particular without compacting the soil, due to the system's small size and weight.

As mentioned before, the same GPR device as used in the system may be used independently from the robot. In other words, the GPR device may be used for conducting a GPR survey without the autonomous robot by manually controlling a movement of the GPR device along a survey path. This makes for a versatile GPR device and a wide field of applications.

Other advantageous embodiments are listed in the dependent claims as well as in the description below.

### BRIEF DESCRIPTION OF THE DRAWINGS

The invention will be better understood and objects other than those set forth above will become apparent from the following detailed description thereof.

Such description makes reference to the annexed drawings, wherein:

FIGS. 1a to 1c show a perspective side view, a top view and a side view, respectively, of an autonomous GPR system according to an embodiment of the invention;

FIGS. 1d and 1e show a cut through and, respectively, a back side view of a connector used in the GPR system according to an embodiment of the invention;

FIG. 2 shows a schematic side view of another embodiment of the GPR system;

FIGS. 3 and 4 show block diagrams of different embodiments of a GPR system according to the invention;

FIG. 5 shows a flow diagram of a method for autonomously conducting a GPR survey according to embodiments of the invention;

FIGS. 6a and 6b show an aspect of an embodiment of such method relating to automatically determining the survey path.

### MODES FOR CARRYING OUT THE INVENTION

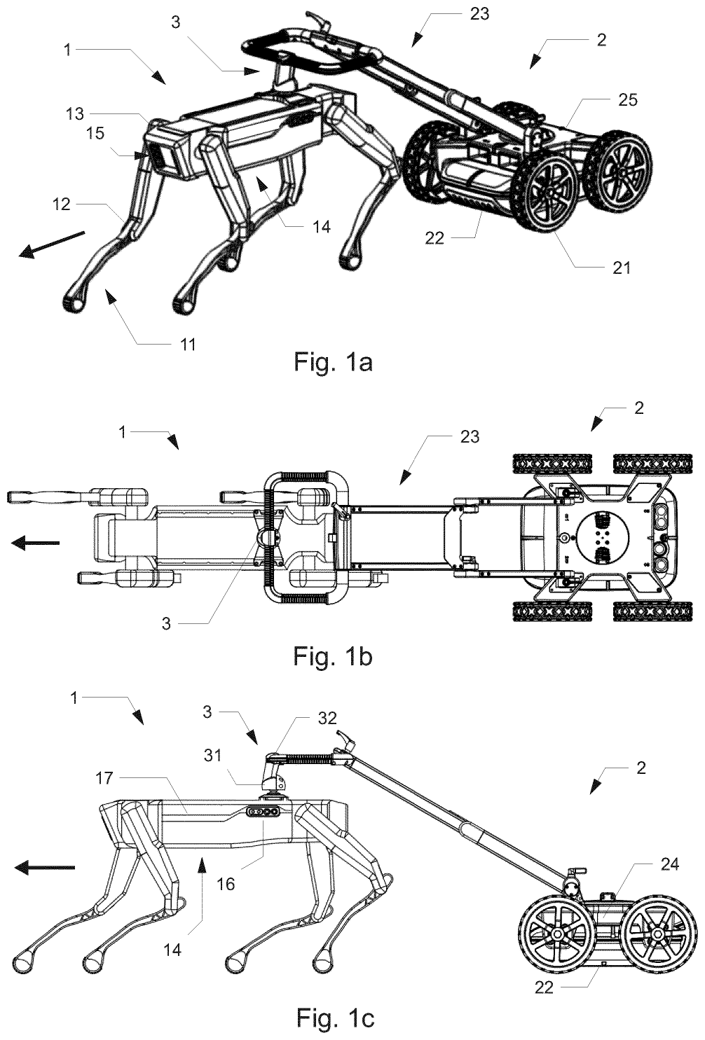

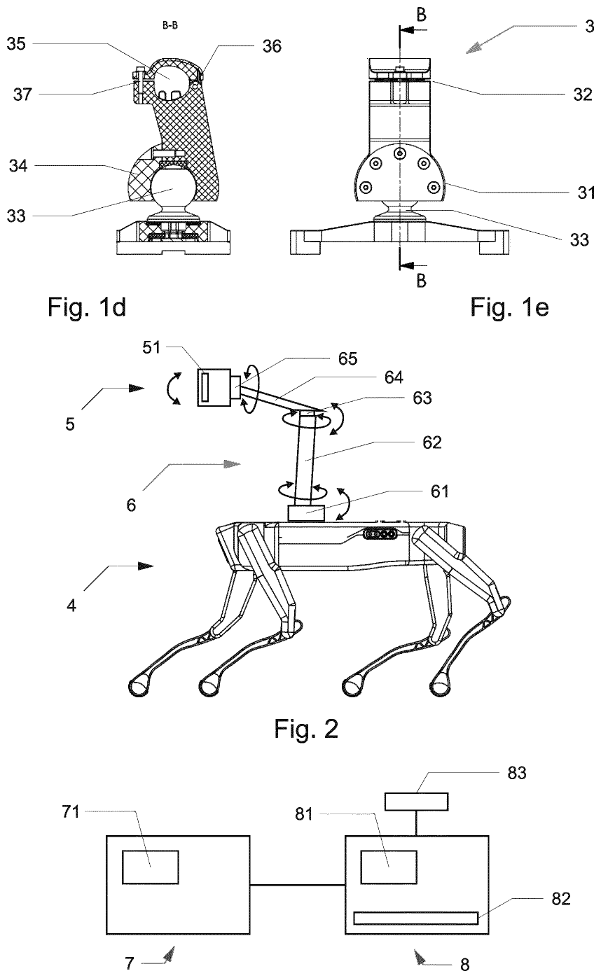

FIGS. 1a to 1c show an embodiment of the autonomous GPR system for acquiring GPR data of a subsurface as described above. The GPR system comprises an autonomous robot 1 and a GPR device 2, which are interconnected by a connector 3. The robot 1 comprises four legs 11 connected to a main body 14. In particular, the legs 11 are connected to lateral sides of the main body, while reference numeral 14 indicates a bottom side of the main body. The legs 11 extend below the bottom side of the main body and may be moved for locomotion. The legs 11 are moved by means of actuators 12, 13 controlled by a robot control unit 17, which is typically arranged in the main body 14.

For conducting a GPR survey, i.e. moving along the survey path, the robot 1 is advantageously configured to move forward as indicated by the bold arrow in FIGS. 1a to 1c. This means that the GPR device 2 is towed behind the robot 1 along the survey path. Alternatively, the robot 1 may be configured to push the GPR device 2 along the survey path or at least parts of the survey path. However, towing the GPR device 2 behind the robot 1 makes a positional control of the GPR device 2 easier, in particular in case of a flexible connector 3 as described later.

The robot 1 further comprises sensors 15, 16, e.g. at least one of a camera, a range sensor, such as an ultrasound sensor, and a lighting sensor, such as a photodetector. The sensors 15, 16 deliver sensor data to the robot control unit 17, which processes the sensor data and controls the movement of the robot 1, in particular of the actuators 12, 13, in order to achieve locomotion along the survey path. An example for such autonomous robot 1 is Spot® by Boston Dynamics.

The GPR device 2 in FIGS. 1a to 1c comprises four wheels 21 supporting a casing 25, in which a GPR antenna 22 is arranged. In particular, the GPR antenna 22 is arranged at a bottom side of the casing 25, as indicated by the arrow of reference numeral 22. The GPR antenna 22 is configured to emit and receive radar waves. For this purpose, the GPR antenna 22 is connected to a GPR control unit 24, typically also arranged in the casing 25. The GPR control unit 24 in particular generates a radar signal to-be-emitted, such as a stepped-frequency continuous-wave (SFCW) signal, and initiates the GPR antenna 22 to emit the signal. The emitted signal travels, in particular in the subsurface, and is reflected or scattered at changes of material, in particular changes of the dielectric constant or the diamagnetic constant. Examples for such changes of material in the subsurface include rebars, pipes, electrical lines, defects, a different type of soil or rock, and groundwater. A part of the reflected or scattered radar waves travels back to the GPR antenna 22, which receives it as received waves. The received waves are then optionally pre-processed, such as filtered, and subsequently recorded as GPR data by the GPR control unit 24 together with position data indicative of the position of the GPR device 2, as e.g. received from a GNSS receiver mounted to the GPR device 2 (not shown in FIGS. 1a to 1c).

Depending on the surface, on which the GPR survey is conducted, the GPR device 2 may not comprise wheels 21, but rather chains, e.g. in rough terrain. Alternatively, the GPR device 2 may not comprise wheels or chains at all, but rather be towed directly over the surface as a sledge, e.g. on an icy surface.

As it may be recognized from FIGS. 1a to 1c, the GPR device 2 may be a stand-alone device, which—when not connected by connector 3—may be used for conducting a GPR survey independently from the robot 1. In particular, the GPR device 2 comprises a communication unit, such as a wireless or Bluetooth module, configured to receive control data from and to transmit the GPR data to an external control unit, such as a field laptop or an iPad.

Further, the GPR device 2 comprises a handle 23 mounted to the casing 25. The handle 23 may be adjustable in height and orientation, e.g. by joints as shown in FIGS. 1a to 1c. In particular, the handle 23 may be mounted to a top side or lateral sides of the casing 25. The handle is advantageously adapted to allow a control of the position and orientation of the GPR device 2. In stand-alone use, an operator typically pushes or pulls the GPR device 2 along the surface path by means of the handle 23, in particular by gripping the handle 23 with the operator's hands. An example of such GPR device 2 is the GPR subsurface GS8000 by Proceq.

In FIGS. 1a to 1c, the GPR device 2 is connected to the autonomous robot 1 by means of the connector 3, which is fixed to the robot 1. The connector 3 is adapted to releasably hold the handle 23. For this purpose, connector 3 comprises a clamp 32 adapted to releasably hold the handle 23. Further, the connector 3 comprises a ball joint 31, which exhibits three rotational degrees of freedom between robot 1 and GPR device 2, i.e. the ball joint 31 allows rotations along a vertical and different horizontal axes. The ball joint 31 does not exhibit a translational degree of freedom between robot 1 and GPR device 2, i.e. displacements between robot 1 and GPR device 2 are prevented by the ball joint 31. Such connector 3 is well suited for towing the GPR device 2 behind the robot 1 since it is flexible with regard to orientation of the GPR device to accommodate for changes in the surface, on which the GPR device is towed. In particular, the ball joint 31 may accommodate the orientation of the GPR device 2 to a changing slope of the surface or to a local obstacle in order to facilitate a smooth locomotion as well as a good coupling of the GPR antenna 22 to the subsurface.

FIGS. 1e and 1d show a detailed view of the connector 3 from the back side, i.e. from opposite the forward direction indicated in FIGS. 1a to 1c, and a cut through the connector 3 along a plane B-B, respectively. A lower part of the connector comprises a ball 33 fixed to a fixation for mounting the connector 3 to the robot. An upper part of the connector comprises a cavity part 34 with a cavity partly as an upper part of the ball 33, thereby forming the counterpart of the ball 33 in the ball joint 31. As described above, rotations of the cavity part 34 around the ball 33 are allowed around three spatial axes, at least up to a certain degree, such as may be inferred from FIG. 1d. In particular, the ball joint 31 may allow for a rotation of at least 30 degree, in particular at least 45 degree, around horizontal axes. Further, a rotation around a vertical axis, e.g. as depicted by B-B in FIG. 1e, may not be restricted by the ball joint 31 at all.

An upper part of the connector 3 comprises a clamp 32 as described above. As illustrated in the cut of FIG. 1d, the clamp 32 comprises a pivotal joint 36 and a screw 37 for closing the clamp 32. In this way, a through-hole 35 is formed, which is adapted to releasably hold the handle of the GPR device. For stability reasons, the connector may be made of metal, in particular aluminium.

In a different embodiment, the connector 3 may be fixed to the GPR device 2, in particular to the handle 23, and releasably connectable to the robot 1. In general, the connector 3 may comprise any kind of flexible element instead of the ball joint 31, or no flexible element at all. In a simple embodiment, the GPR device 2 may be connected to the robot 1 by a tow rope acting as connector 3.

Further, the mounting position of the connector 3 on the robot 1 may, in general, be different than in FIGS. 1a to 1c. A high mounting position, e.g. on the top side of the main body 14, has the advantage of better manoeuvrability, e.g. in case of obstacles on the surface. However, a low mounting position, e.g. on the bottom side of main body 14 or a lateral side, such as a back side facing the GPR device 2, may be desirable for a smaller overall height of the GPR system, e.g. in height-restricted survey areas, such as a construction site.

FIG. 2 shows another embodiment of the GPR system. The system, again, comprises an autonomous robot 4 and a GPR device 5 interconnectable by means of a connector 6. In this embodiment, the GPR device 5 may be of a different type than the one described with respect to FIGS. 1a to 1c. In particular, the GPR device 5 may be a stand-alone device, again equipped with a GPR antenna 51, which is adapted to conduct a GPR survey by being moved along a survey path, e.g. carried along the survey path, in other words a hand-held GPR device. Such GPR device 5 may be mounted to the robot 4 directly, as depicted in FIG. 2. In other words, the robot 4, and in particular the connector 6, in an operational position, supports a major part, e.g. at least 50% or 80% or even 100%, of a weight of the GPR device 5.

The connector 6 shown in FIG. 2 comprises an arm with two arm elements 62, 64 adapted to move the GPR device 5 in six degrees of freedom relative to the robot 4. This is achieved by arm actuators 61, 63, 65, which may be rotatable and/or pivotal around one or two axes, and actively controlled, in particular by the robot control unit. This is useful to orient the GPR antenna 51 towards any surface regardless of its slope, e.g. in case of a wall or ceiling, and to change a distance of the GPR device 5 to the surface, e.g. in order to achieve a good coupling or to prevent mechanical damage to the GPR device 5, e.g. in case of surface roughness. Thus, a good quality of acquired GPR data is facilitated.

In general, both, the autonomous robot and the GPR device may be stand-alone devices, i.e. adapted to perform their respective tasks independently from the other device. Such situation is depicted in the block diagram of FIG. 3. The autonomous GPR system comprises an autonomous robot 7 and a GPR device 8. The robot 7 comprises a robot control unit 71 configured to control all processes regarding the robot 7, in particular configured to control autonomous locomotion of the robot 7. The GPR device 8 comprises a GPR control unit 81 configured to control all processes regarding the GPR device 8, in particular configured to control acquiring GPR data by means of the GPR antenna 82. A GNSS antenna 83, or any other positioning system, is mounted to the GPR device 8 and configured to determine the position of the GPR device 8. The GPR control unit 81 receives position data from the GNSS antenna 83 and associates it to the corresponding GPR data. In such embodiment, the position of the GPR device is measured directly.

Alternatively, the GNSS antenna 83, or any other positioning system, may be mounted to the robot 7 instead, or position data from an internal positioning system of the robot 7, e.g. including an accelerometer and/or a magnetometer, may be used. In such case, it is advantageous to take into account a distance between robot 7 and GPR device 8, e.g. as fixed by the connector between the two devices, as well as an orientation of the GPR system when moving along the survey path. The orientation may be inferred from an orientation of the robot 7, e.g. as measured by a magnetometer of the robot, and the assumption that the GPR device 8 is towed behind the robot 7. Thus, the position of the robot 7 together with the orientation of the robot 7 may be used as data indicative of the position of the GPR device 8.

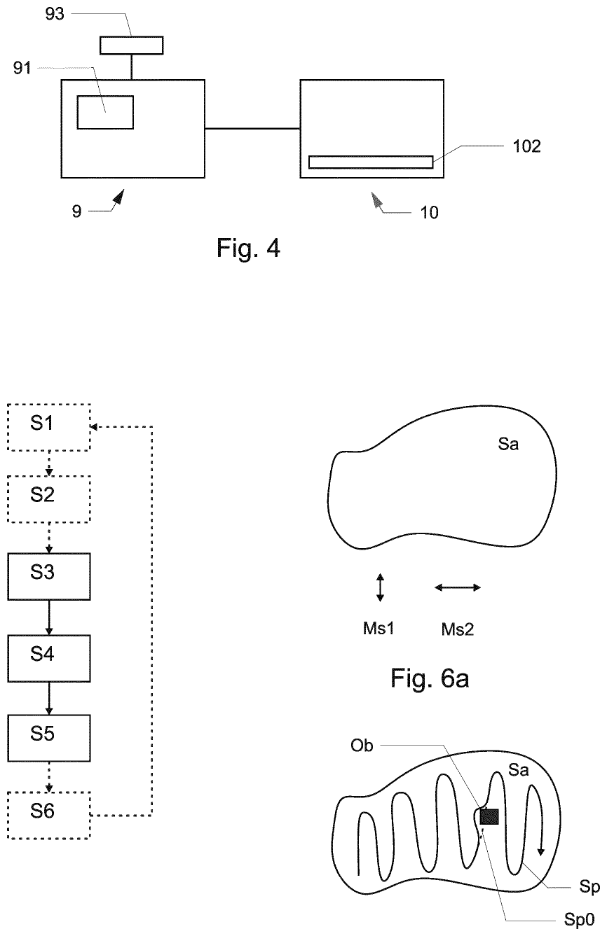

In a different embodiment, the GPR system may work—at least partly—in a master-slave configuration, as depicted in FIG. 4. The autonomous robot 9 again comprises a robot control unit 91 configured to control all processes regarding the robot 9, in particular configured to control autonomous locomotion of the robot 9. The robot control unit 91 may further receive position data from a GNSS receiver 93, or any other positioning system, mounted to the robot 9 as shown, or to the GPR device 10 with the GPR antenna 102. In contrast to the embodiment of FIG. 3, the robot control unit 91 now is configured to control—at least a part of—the processes regarding the GPR device 10. Accordingly, the robot control unit 91 may e.g. be configured to control acquiring GPR data by means of the GPR antenna 102. Thus, the GPR device 10 may or may not comprise its own GPR control unit (not shown in FIG. 4).

In general, the autonomous robot, e.g. in FIGS. 3 and 4, may not be a legged robot, but instead comprise wheels or chains. Depending on the surface, on which the GPR survey is to be conducted, this may facilitate a more efficient, e.g. faster or less energy-consuming, way of locomotion.

In an even more general case, the autonomous robot may be an airborne drone configured to carry or tow the GPR device. For most applications, however, the robot advantageously is not airborne since this would bring about strict limitations in terms of payload, i.e. a maximum possible weight of the GPR device, and distance to ground. In particular, a land-based robot may be better suited for acquiring GPR data with high data quality than an airborne robot because of a better coupling of the radar waves into the subsurface due to the smaller distance between GPR antenna and the surface of the subsurface.

FIG. 5 shows a flow diagram of an embodiment of a method for autonomously conducting a GPR survey of a subsurface. The method may in particular be carried out by any of the GPR systems described above.

In step S1, the GPR device is mechanically connected to the autonomous robot, in particular by means of the connector. Step S1 is optional in the sense that it may be left out if the GPR device and the robot are already interconnected, e.g. subsequent to a previous GPR survey.

In step S2, optionally, a survey geometry is received. The survey geometry may in particular include a survey area, i.e. the area in which the GPR survey is to be conducted, e.g. as defined by its dimensions and optionally a shape of the area. In a simple case, the survey geometry comprises a predefined survey path. The survey geometry is advantageously input into the robot control unit, which is configured to initiate locomotion of the robot according to the survey geometry. In a different embodiment, the survey geometry includes positions of delimiters as e.g. measured by sensors of the robot, as described above.

In step S3, the survey path is defined in the survey geometry. An example is depicted in FIGS. 6a, 6b and described below.

In step S4, the robot is caused to autonomously move along the survey path. Because of the mechanical connection between robot and GPR device, the robot thereby controls a position of the GPR device.

In step S5, the GPR device transmits radar waves into the subsurface and records their echoes as GPR data together with position data indicative of the position of the GPR device. Examples of position data have been given above, e.g. in the context of FIGS. 3 and 4. The GPR data are advantageously transmitted to an external device, in particular in real time, and stored as well as optionally processed and displayed on the external device, e.g. an iPad.

In optional step S6, after recording the GPR data, the GPR device may be disconnected from the autonomous robot. Thus, robot and GPR device may be used independently as stand-alone device, or a further GPR survey may be conducted autonomously with the GPR system.

FIGS. 6a and 6b schematically illustrate an embodiment of steps S2 and S3 of the above method. FIG. 6a depicts the survey geometry that is received in step S2, i.e. the data required by the robot control unit in order to control locomotion of the GPR system. In this case, the survey geometry includes a survey area Sa, given in terms of shape and dimensions, a first measurement spacing Ms1 in direction along the survey path and a second measurement Ms2 in direction across the survey path.

The system, in particular the robot control unit, then automatically generates the survey path based on the input survey geometry, e.g. by solving an optimization problem, in particular by minimizing a length of the survey path or an average curvature of the survey path. This corresponds to step S3 of FIG. 5.

FIG. 6b shows an example of a generated survey path Sp0. In step S4 of FIG. 5, the robot would then be caused to autonomously move along the survey path Sp0. However, the survey path Sp0 may contain an obstacle Ob, such as a tree, a rock or a pillar, which was not part of the input survey geometry. Such obstacle Ob does not pose a problem to the described GPR system due to the autonomous capacities of the robot. When following the survey path, the robot checks the surroundings for obstacles, e.g. by means of sensors, such as a camera or a proximity sensor. When detecting an obstacle Ob, an actual survey path Sp followed by the robot is adjusted, e.g. to make a deviation around the obstacle Ob, and subsequently returning to the initially generated survey path Sp0.

As is evident from the above, such autonomous GPR system and method of acquiring GPR data autonomously are versatile in terms of applications and adaptable to a variety of survey geometries and surface properties, e.g. in the field or on/in man-made structures, such as buildings, bridges, roads or off-shore oil platforms. Also, such system and method are efficient, in particular saving time on the part of the operator, and deliver good-quality GPR data with reliable position data.

1. A method for autonomously conducting a GPR survey of a subsurface bounded by a surface by a GPR device,
wherein the GPR device is mechanically connected to an autonomous robot, the method comprising:
defining a survey path on the surface in a survey geometry,
causing the robot to autonomously move along the survey path, thereby controlling a position of the GPR device, and
via the GPR device, transmitting radar waves into the subsurface and recording their echoes as GPR data together with position data indicative of the position of the GPR device.

2. The method of claim 1 further comprising:
receiving the survey geometry,
in particular wherein the receiving the survey geometry comprises obtaining map data defining the survey geometry.

3. The method of claim 2,
wherein the receiving the survey geometry comprises detecting delimiters of the survey geometry using sensors.

4. The method of claim 1,
wherein the GPR device is adapted to perform a GPR survey in connection with but also without the autonomous robot,
the method further comprising carrying out several surveys and, for each survey,
mechanically connecting the GPR device to the autonomous robot,
after recording the GPR data, disconnecting the GPR device from the autonomous robot.

5. The method of claim 1,
wherein the GPR device comprises a radar antenna arranged on a cart with wheels or on a sledge, which is mechanically connected to the autonomous robot via a connector, in particular wherein the connector comprises a ball joint,
the method further comprising
towing the GPR device behind the autonomous robot along the survey path.

6. The method of claim 1, further comprising:
lowering or raising the connector dependent on a position of the GPR device on the survey path, in particular in bends along the survey path,
in particular, thereby lifting a part of the wheels of the cart from the surface.

7. The method of claim 1,
wherein the autonomous robot is a robot with legs,
wherein causing the robot to move along the survey path comprises moving the legs of the robot, thereby moving the robot along the survey path.

8. The method of claim 1, further comprising:
controlling a distance between the GPR device and the surface, in particular to be below a threshold, in particular by moving the legs of the robot to adjust the distance.

9. The method of claim 1,
wherein the survey geometry comprises a survey area and further survey parameters, in particular a measurement spacing,
wherein defining the survey path-comprises
generating the survey path to cover the survey area and to take into account the further survey parameters, in particular the measurement spacing.

10. An autonomous GPR system for acquiring GPR data of a subsurface bounded by a surface, comprising:
an autonomous robot, in particular with legs, and
a GPR device.

11. The system of claim 10,
wherein the robot comprises;
at least two, in particular four, legs with actuators,
a robot control unit configured to control the actuators to autonomously move the robot on the surface along a survey path in a walking mode by the legs.

12. The system of any of claims 10 to 14 claim 10, further comprising:
a position determining unit, in particular a GNSS receiver,
wherein the GPR device comprises
a GPR antenna configured to transmit and receive radar waves,
a GPR control unit connected to the GPR antenna and to the position determination unit, and comprising a data recorder recording GPR data received from the GPR antenna together with corresponding position data received from the position determination unit.

13. The system of claim 12,
wherein the position determining unit is mechanically mountable on the GPR device.

14. The system of claim 12,
wherein the position determining unit is mechanically mountable on the robot,
wherein the position data includes a position and orientation of the robot.

15. The system of claim 12,
wherein the GPR device comprises a cart with wheels or a sledge, to which the GPR antenna is mounted,
in particular wherein the cart or sledge comprises a handle.

16. The system of claim 10, further comprising:
a connector configured to removably connect the GPR device to the robot.

17. The system of claim 16,
wherein the connector comprises a ball joint.

18. The system of claim 16,
wherein the connector exhibits three rotational degrees of freedom between the robot and the GPR device,
and in particular wherein the connector is rigid along three translational degrees of freedom between the robot and the GPR device.

19. The system of claim 16,
wherein the robot further comprises
a main body having a bottom side and a top side,
wherein the legs extend from the main body beyond the bottom side,
wherein the connector is arranged on the top side.

20. The system of claim 15,
wherein the connector comprises a clamp configured to removably hold the handle.

21. The system of claim 11,
wherein the robot comprises a lift drive connected to the robot control unit and configured to lower or raise the connector,
in particular wherein the lift drive is adapted to move the connector between a first and a second vertical position, thereby tilting the cart between a first and a second tilting position.

22. The system of claim 11,
wherein the robot control unit is configured to generate the survey path based on a survey area and further survey parameters, in particular a measurement spacing and/or resolution,
in particular such that the GPR data covers the survey area.

23. The system of claim 10,
wherein the autonomous robot comprises wheels or chains for locomotion.

24. The system of claim 16,
wherein the GPR device is directly mountable to the robot by the connector,
in particular wherein the GPR device, in an operating position, is not in contact with the surface.

25. The system of claim 16,
wherein the robot control unit is configured to control a position and in particular an orientation of the GPR device.

26. The system of claim 16,
wherein the connector comprises an arm with at least one arm actuator connected to the robot control unit,
in particular wherein the at least one arm actuator is configured to move the GPR device in at least five, in particular six, degrees of freedom relative to a main body of the robot.

27. The system of claim 10, wherein the robot control unit is adapted to
define a survey path on the surface in a survey geometry
cause the robot to autonomously move along the survey path, thereby controlling a position of the GPR device,
by the GPR device, transmitting radar waves into the subsurface and recording their echoes as GPR data together with position data indicative of the position of the GPR device.

28. A method of operating the system of claim 10 for at least one of:
mapping geological features in the subsurface,
locating man-made features or defects in the subsurface, in particular in a construction or a pavement,
estimating an amount of biomass, in particular roots, in the subsurface.

29. A method of operating the GPR device from the GPR system of claim 10 for conducting a GPR survey without the autonomous robot by manually controlling a movement of the GPR device along a survey path.
